(19) United States
(12) Patent Application Publication
(10) Pub. No.: US 2011/0198505 A1
(43) Pub. Date: Aug. 18, 2011

(54) RADIATION DETECTOR AND RADIATION DETECTION SYSTEM

(75) Inventors: Yohei Ishida, Honjo-shi (JP); Satoshi Okada, Tokyo (JP); Kazumi Nagano, Fujisawa-shi (JP); Keiichi Nomura, Honjo-shi (JP); Yoshito Sasaki, Honjo-shi (JP)

(73) Assignee: CANON KABUSHIKI KAISHA, Tokyo (JP)

(21) Appl. No.: 13/025,707

(22) Filed: Feb. 11, 2011

(30) Foreign Application Priority Data
Feb. 18, 2010 (JP) 2010-033852
Jan. 19, 2011 (JP) 2011-009061

(51) Int. Cl. G01T 1/208

(52) U.S. Cl. 250/363.01; 250/366

(57) ABSTRACT

A radiation detector includes a sensor panel including a photodetector and peripheral circuitry, the photodetector includes a two-dimensional array of photoelectric conversion elements arranged on a substrate, the peripheral circuitry is electrically connected to the photoelectric conversion elements and is disposed on the periphery of the photodetector; a scintillator layer is disposed on the photodetector of the sensor panel, the scintillator layer converts radiation into light that is detectable by the photoelectric conversion elements; a scintillator protection member covers the scintillator layer; and a sealing resin seals the scintillator layer, the sealing resin is disposed between the sensor panel and the scintillator protection member on the periphery of the scintillator layer; the sealing resin is disposed on top of the peripheral circuitry; and particles containing a radiation-absorbing material are dispersed in the sealing resin.

### BACKGROUND OF THE INVENTION

1. Field of the Invention

The present invention relates to a radiation detector and a radiation detection system for use in medical diagnostic equipment, nondestructive testing equipment, and other equipment; more particularly, the preset invention relates to a radiation detector and a radiation detection system for use in digital radiography.

2. Description of the Related Art

X-ray film systems generally used for X-ray photography employ a fluorescent screen containing an X-ray fluorescent layer and a film. Digital radiation detectors that include a scintillator layer and a two-dimensional photodetector are also being used and can potentially replace the use of X-ray film systems. The scintillator layer functions as a wavelength converter that can convert X-rays into visible light; and the two-dimensional photodetector converts the visible light into an electric signal which can be digitally processed. Accordingly, the two-dimensional photodetector, which includes an array of photoelectric conversion elements arranged in two dimensions, play a key role in the conversion of X-rays into electric signals. Such digital radiation detectors offer numerous advantages over the film based systems. For example, digital radiation detectors can generate images with excellent image characteristics based on digital image processing; and data detected by these detectors can be immediately transferred to a networked computer system for data sharing. Thus, digital radiation detectors are actively studied.

Many digital radiation detectors are currently known. U.S. Pat. No. 6,262,422 discloses a digital radiation detector that includes a sensor panel and a scintillator layer disposed on the sensor panel. The sensor panel includes a photodetector in which a plurality of electrical elements, such as photosensors and thin-film transistors (hereinafter referred to as TFT's), are arranged in two dimensions. The scintillator layer can convert radiation into light that is detectable by a photosensor. The top surface and end faces of the scintillator layer are protected with a scintillator protection layer, a reflective film, and a reflective-film-protection layer. These protective layers prevent the intrusion of water and other foreign substances into the scintillator layer, but tend to increase the overall size and weight of the detector.

Japanese Patent Laid-Open No. 2004-177217 discloses a radiation detector in which peripheral circuitry including an amplifying element that amplifies signals detected by a photosensor is disposed on the periphery of a photodetector. In order to prevent deterioration in the characteristics of the amplifying element by radiation exposure, this radiation detector includes a frame formed of an X-ray absorbing material and a protective member formed of silver filler on the peripheral circuitry.

In the radiation detector according to Japanese Patent Laid-Open No. 2004-177217, however, the structures for protecting the peripheral circuitry from radiation increase the size and thickness of a sensor panel.

### SUMMARY OF THE INVENTION

In order to solve the problems described above, a radiation detector according to one aspect of the present invention includes a sensor panel including a photodetector and peripheral circuitry, the photodetector includes a two-dimensional array of photoelectric conversion elements arranged on a substrate, the peripheral circuitry being electrically connected to the photoelectric conversion elements and being disposed on the periphery of the photodetector; a scintillator layer disposed on the photodetector of the sensor panel, the scintillator layer converting radiation into light that is detectable by the photoelectric conversion elements; a scintillator protection member configured to cover the scintillator layer; and a sealing resin configured to seal the scintillator layer, the sealing resin being disposed between the sensor panel and the scintillator protection member on the periphery of the scintillator layer; the sealing resin is disposed on top of the peripheral circuitry, and particles containing a radiation-absorbing material are dispersed in the sealing resin.

In accordance with the present invention, the sealing resin sealing the scintillator layer can reduce the amount of radiation incident on the peripheral circuitry, protect the scintillator from changes in environmental conditions and reduce damage to the peripheral circuitry without the installation of another radiation-shielding member.

Further features of the present invention will become apparent from the following description of exemplary embodiments with reference to the attached drawings.

### BRIEF DESCRIPTION OF THE DRAWINGS

FIG. 1 is a cross-sectional view of an X-ray detector according to a first embodiment of the present invention.

FIG. 2 is a plan view of the X-ray detector illustrated in FIG. 1.

FIG. 3 is a sensor panel of the X-ray detector illustrated in FIG. 1.

FIG. 4 is a cross-sectional view of an X-ray detector according to a second embodiment of the present invention.

FIG. 5 is a cross-sectional view of an X-ray detector according to a third embodiment of the present invention.

FIG. 6 is a schematic view of a radiation detection system according to one embodiment of the present invention.

FIG. 7 is a circuit diagram of the sensor panel illustrated in FIG. 3.

### DESCRIPTION OF THE EMBODIMENTS

A radiation detector according to the present invention includes a sensor panel, which includes a photodetector and peripheral circuitry; a scintillator layer disposed on the photodetector; a scintillator protection member; and a sealing resin disposed between the sensor panel and the scintillator protection member on the periphery of the scintillator layer. The sealing resin is disposed on top of the peripheral circuitry, and particles containing a radiation-absorbing material are dispersed in the sealing resin.

Exemplary embodiments of the present invention will be now described in detail with reference to the enclosed drawings. As used herein, the term “radiation” includes electromagnetic waves, such as alpha rays, beta rays, and gamma rays, as well as X-rays.

### First Embodiment

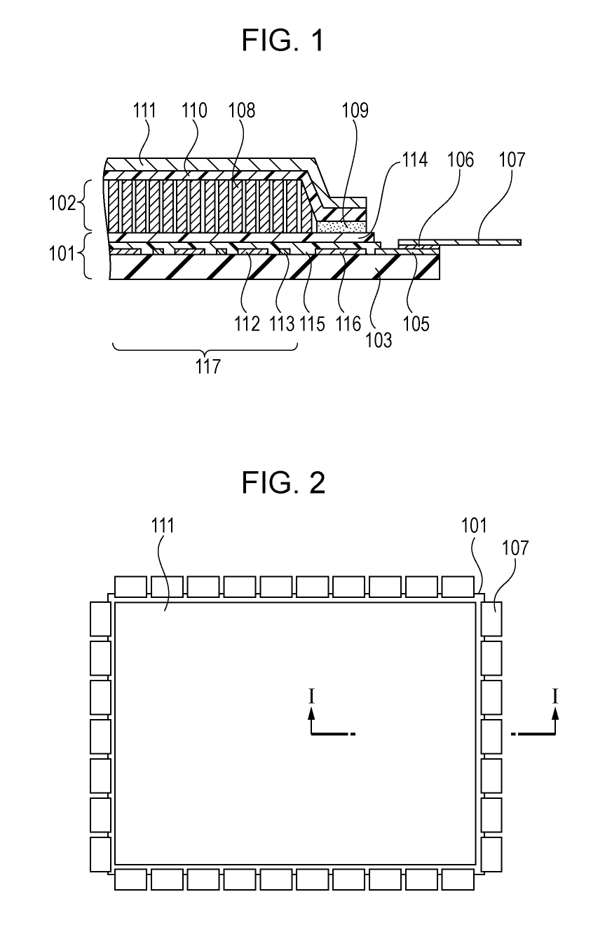

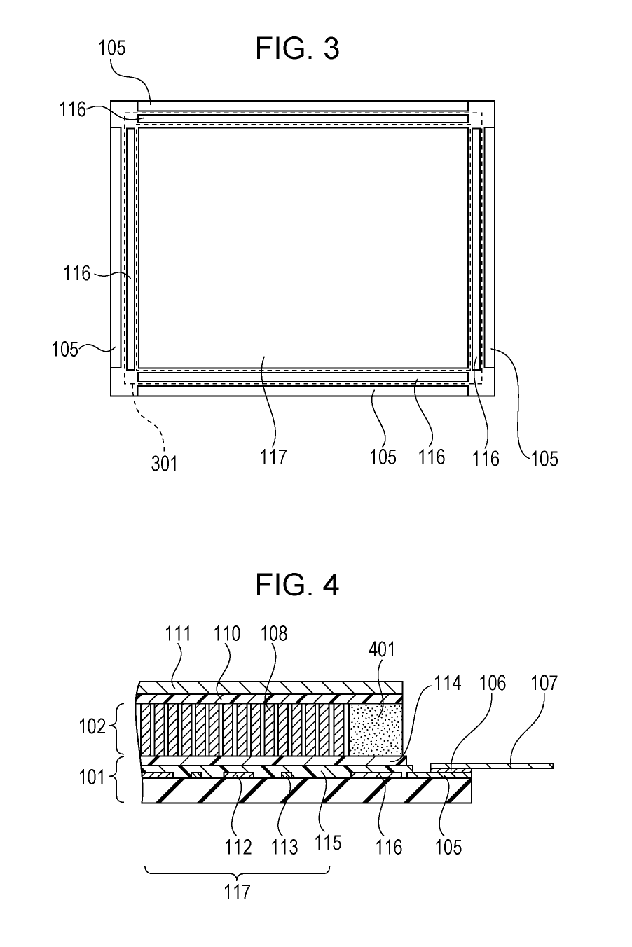

FIG. 2 is a plan view of a radiation detector according to a first embodiment of the present invention. FIG. 1 is a cross-sectional view taken along the line I-I in FIG. 2. FIG. 3 is a plan view of the sensor panel illustrated in FIGS. 1 and 2. Like reference numerals designate like parts throughout these figures.

As illustrated in FIG. 1, a sensor panel 101 includes photoelectric conversion elements 112 and TFT's (not shown) formed of a semiconductor film on an insulating substrate 103, for example, formed of glass or resin. The photoelectric conversion elements 112 or the TFT's are connected to wires 113. The photoelectric conversion elements 112 and the wires 113 are two-dimensionally arranged to form a photodetector 117. Peripheral circuitry 116 processes (for example, amplifies) signals sent from the photoelectric conversion elements 112 through wires 113. As illustrated in FIG. 3, the peripheral circuitry 116 is disposed on the periphery of the photodetector 117.

The sensor panel 101 is connected to external wiring 107 through a connecting lead 105, such as a bonding pad. This connecting lead 105 is electrically connected to the external wiring 107, such as a flexible wiring board, through a wiring connector 106, such as solder or an anisotropic conductive adhesive film (ACF). Thus, the sensor panel 101 is connected to an external electrical circuit. The sensor panel 101 further includes a sensor protection layer (a first protective layer) 115, for example, formed of silicon nitride and a scintillator base layer (a second protective layer) 114, for example, formed of a resin film. The scintillator base layer 114 rigidly protects the photoelectric conversion elements 112. These components constitute the sensor panel 101.

On the insulating substrate 103 is formed a photoelectric conversion unit (photodetector) including the photoelectric conversion elements 112, the wires 113, and the TFT's (not shown). Thus, the material of the insulating substrate 103 may suitably be glass or resin such as heat resistant plastic. A scintillator layer 102 converts radiation into light. The photoelectric conversion elements 112 convert the light into electric charges and may be formed of amorphous silicon, polysilicon, or single-crystal silicon. The photoelectric conversion elements 112 may be, but are not limited to, metal-insulator semiconductor (MIS) sensors, positive-intrinsic-negative (PIN) sensors, or TFT sensors.

The wires 113 are a portion of signal wires for reading signals photoelectrically converted by the photoelectric conversion elements 112 through TFT's, a portion of signal wires for reading signals processed by the peripheral circuitry 116, bias wires through which a voltage (Vs) is applied to the photoelectric conversion elements 112, or drive wires for driving TFT's. Signals photoelectrically converted by the photoelectric conversion elements 112 are read by the TFT's and are output to an external signal-processing circuit through the peripheral circuitry 116 and the connecting lead 105. TFT gates are arranged in lines. Each line of TFT gates is connected to a drive wire and is selected by a TFT drive circuit (not shown). Examples of the material of TFT channels include, but are not limited to, amorphous silicon, polysilicon, single-crystal silicon, and amorphous oxide semiconductors.

Examples of the material of the sensor protection layer (first protective layer) 115 include, but are not limited to, SiN, TiO₂, LiF, Al₂O₃, MgO, poly(phenylene sulfide) resin, fluorocarbon resin, polyetheretherketone resin, liquid crystal polymers, polyethernitrile resin, polysulfone resin, polyethersulfone resin, polyarylate resin, polyamideimide resin, polyetherimide resin, polyimide resin, epoxy resin, and silicone resin. Light converted by the scintillator layer 102 passes through the protective layer 115 during radiation. It is therefore desirable that the sensor protective layer 115 and the scintillator base layer 114 have high transmittance in the wavelength range of light converted by the scintillator layer 102.

The scintillator base layer (second protective layer) 114 may be formed of any material resistant to a thermal process during the formation of the scintillator layer 102 (for example, a material resistant to temperatures of 200° C. or more for a scintillator layer having a columnar crystal structure). Examples of such a material include, but are not limited to, polyamideimide resin, polyetherimide resin, polyimide resin, epoxy resin, and silicone resin. If the scintillator base layer 114 is to be formed of the material of the sensor protective layer 115, the sensor protective layer 115 can also serve as the scintillator base layer 114. Thus, the scintillator base layer 114 can be omitted.

A scintillator protection layer 110 and a reflective layer 111 are disposed on the scintillator layer 102. The scintillator layer 102 can convert radiation into light that is detectable by the photoelectric conversion elements 112 and contains a plurality of columnar crystals 108, as illustrated in FIG. 1. The columnar crystals 108 can propagate light generated by a scintillator. Thus, the scintillator containing the columnar crystals 108 causes little light scattering and can improve resolution. The scintillator layer 102 forming the columnar crystals 108 is suitably mainly composed of halogenated alkaline, for example, the scintillator layer 102 comprises one selected from the group consisting of Thallium activated Cesium Iodide (CsI:Tl), Cesium Iodide doped with Sodium (CsI:Na), CsBr:Tl, NaI:Tl, LiI:Eu, or KI:Tl. For example, CsI:Tl can be formed by co-evaporation of CsI and Tl.

In the present embodiment, the scintillator protection layer 110 constitutes a scintillator protection member. A sealing resin 109 is disposed on the periphery of the scintillator layer 102 between the sensor panel 101 and the scintillator protection layer 110 so as to seal the scintillator layer 102.

The sealing resin 109, in cooperation with the scintillator protection layer 110, has a moisture barrier function that can prevent foreign material (e.g., water or vapor) from entering the scintillator layer 102. Thus, in the present embodiment, the sealing resin 109 can be formed of a material having high moisture barrier performance or low water permeability. For example, the sealing resin 109 is suitably epoxy or acrylic resin or may be silicone, polyester, polyolefin, polyamide, or polyimide resin. In other embodiments, the sealing resin 109 may be suitably formed of a thermal-shielding material that can prevent high temperatures from entering the scintillator 102, or a porous material that can promote exhaust of high temperature from within the scintillator 102 to an outer surface thereof. As a suitable resin material that can manage temperature in this manner while still sealing the scintillator 102 carbon graphite or composites thereof may be used.

The sealing resin 109 is disposed on top of the peripheral circuitry 116 to reduce the amount of X-rays incident on the peripheral circuitry 116. In FIG. 3, the sealing resin is applied to a region 301 between the broken lines. Particles containing an X-ray absorbing material are dispersed in the sealing resin 109. For example, the particles are fine particles of metal, such as molybdenum (Mo), tungsten (W), or lead (Pb), or fine particles of oxide, such as barium oxide (BaO), cerium oxide (CeO₂), gadolinium oxide (Gd₂O₃), dysprosium oxide (Dy₂O₃), or titanium oxide (TiO₂). Elements in the peripheral circuitry 116 are likely to malfunction because of X-ray irradiation. The dispersion of the particles can protect these elements from X-rays while maintaining the moisture barrier function.

In the sealing resin 109, it is desirable that the ratio of the particles containing an X-ray absorbing material to the total weight of the sealing resin and the particles be 30% by weight or more and 90% by weight or less. When this ratio is less than 30% by weight, the X-ray absorption effects are reduced. When this ratio is more than 90% by weight, the sealing performance is lowered.

The scintillator protection layer 110 has a moisture barrier function that prevents water intrusion into the scintillator layer 102 from the outside air and also has an impact protection function that prevents the structural breakdown of the scintillator layer 102 caused by an impact. In the case of the scintillator layer 102 having a columnar crystal structure, the scintillator protection layer 110 preferably has a thickness of 20 μm or more and 200 μm or less. The scintillator protection layer 110 having a thickness smaller than 20 μm cannot completely cover asperities and splash portion on the surface of the scintillator layer 102, possibly resulting in a poor moisture barrier function. The splash is a defect caused by the bumping of a scintillation material and has no fixed amount or size. The splash portion has irregular thicknesses and densities. The scintillator protection layer 110 having a thickness larger than 200 μm significantly scatters light generated in the scintillator layer 102 or light reflected by the reflective layer 111, possibly resulting in low resolution and modulation transfer function (MTF) of images obtained. Examples of the material of the scintillator protection layer 110 include, but are not limited to, common organic sealing materials, such as silicone resin, acrylic resin, and epoxy resin, and hot-melt resin, such as polyester, polyolefin, and polyamide hot-melt resin. In particular, resin having low water permeability is desirable. The scintillator protection layer 110 is suitably a polyparaxylylene organic film formed by chemical vapor deposition (CVD). The scintillator protection layer 110 may suitably be formed of a hot-melt resin described below.

Hot-melt resin melts at high temperature and hardens at low temperature. Hot-melt resin in a molten state is sticky, whereas hot-melt resin in a solid state at normal temperature is not sticky. Since hot-melt resin does not contain polar solvent, solvent, or water, the hot-melt resin does not dissolve the scintillator layer 102 (for example, a scintillator layer having a columnar crystal structure formed of halogenated alkaline). Thus, hot-melt resin can be used as the scintillator protection layer 110. Hot-melt resin is different from adhesive resin that is formed from a thermoplastic resin dissolved in a solvent by a solvent coating method and is curable by solvent evaporation. Hot-melt resin is also different from chemical-reaction-type adhesive resin, such as epoxy resin, which is formed by a chemical reaction. Hot-melt resin materials can be classified by the type of the main component, that is, the base polymer (the base material) and may be based on polyolefin, polyester, or polyamide. As the material of the scintillator protection layer 110, it is important for hot-melt resin to have high moisture barrier performance and high transparency to visible light generated by the scintillator. Hot-melt resin that satisfies the moisture barrier performance required for the scintillator protection layer 110 may be polyolefin resin and polyester resin. In particular, polyolefin resin advantageously has low moisture absorbency. Polyolefin resin also advantageously has high optical transparency. Thus, the scintillator protection layer 110 may be formed of hot-melt polyolefin resin. Polyolefin resin can contain as the main component at least one selected from the group consisting of an ethylene-vinyl acetate copolymer, an ethylene-acrylic acid copolymer, an ethylene-acrylate copolymer, an ethylene-methacrylic acid copolymer, an ethylene-methacrylate copolymer, and ionomer resin. Hot-melt resin mainly composed of an ethylene-vinyl acetate copolymer may be Hirodine 7544 (trade name, manufactured by Hirodine Kogyo Co., Ltd.). Hot-melt resin mainly composed of an ethylene-acrylate copolymer may be O-4121 (trade name, manufactured by Kurabo Industries Ltd.). Hot-melt resin mainly composed of an ethylene-methacrylate copolymer may be W-4110 (trade name, manufactured by Kurabo Industries Ltd.). Hot-melt resin mainly composed of an ethylene-acrylate copolymer may be H-2500 (trade name, manufactured by Kurabo Industries Ltd.). Hot-melt resin mainly composed of an ethylene-acrylic acid copolymer may be P-2200 (trade name, manufactured by Kurabo Industries Ltd.). Hot-melt resin mainly composed of an ethylene-acrylate copolymer may be Z-2 (trade name, manufactured by Kurabo Industries Ltd.).

The reflective layer 111 reflects light generated in the scintillator layer 102 traveling in a direction away from the photoelectric conversion elements 112 and directs the light to the photoelectric conversion elements 112. Thus, the reflective layer 111 can improve light-use efficiency. The reflective layer 111 can also block extraneous light other than light generated in the scintillator layer 102, thereby preventing noise from entering the photoelectric conversion elements 112. The reflective layer 111 may be metallic foil or a thin metal film and may have a thickness of 1 μm or more and 100 μm or less. The reflective layer 111 having a thickness smaller than 1 μm tends to have a pinhole defect during the formation of the reflective layer 111 and has a small light-shielding effect. The reflective layer 111 having a thickness larger than 100 μm may result in an increase in the exposure dose of a subject and may make it difficult to completely cover a difference in level between the scintillator layer 102 and the surface of the sensor panel 101. The reflective layer 111 may be formed of a metallic material, such as aluminum, gold, copper, or aluminum alloy, particularly a high-reflectance material, such as aluminum or gold.

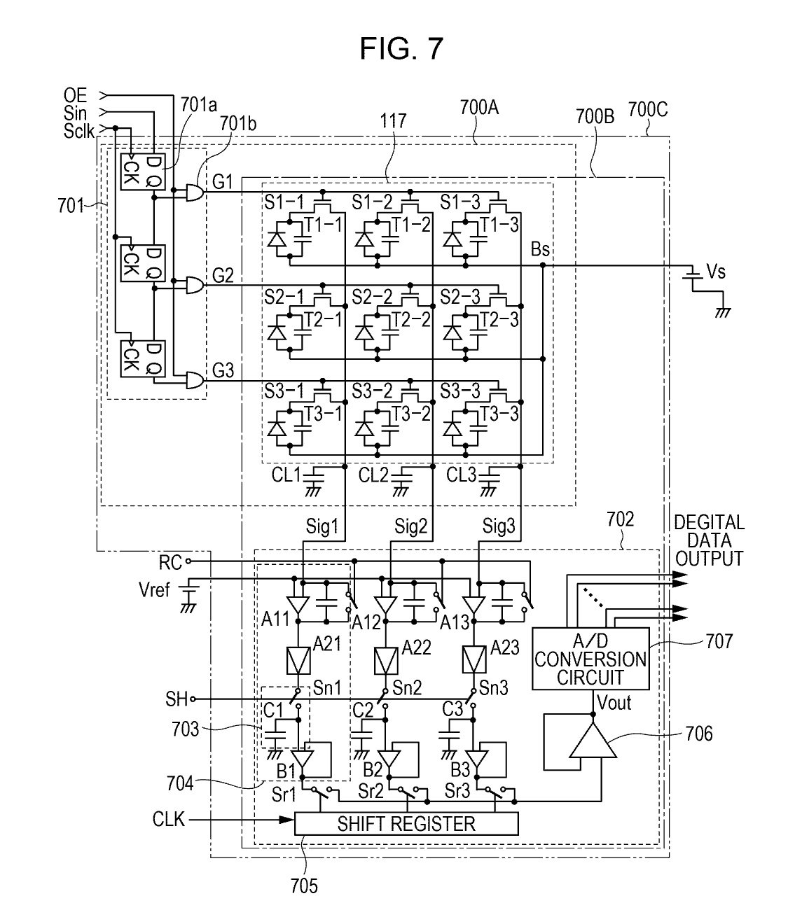

FIG. 7 is a circuit diagram of the sensor panel illustrated in FIG. 3. The peripheral circuitry 116 of the sensor panel protected by the sealing resin 109 containing an X-ray shielding material will be described below. The peripheral circuitry 116 includes at least one of a drive circuit and a readout circuit and is disposed on the insulating substrate. Thus, the sensor panel can include the photodetector 117, a structure 700A including a drive circuit 701, a structure 700B including a readout circuit 702, and a structure 700C including the drive circuit 701 and the readout circuit 702. Therefore peripheral circuitry 116 is arranged along at least one side of the periphery of the photodetector 117. Although the drive circuit 701 and the readout circuit 702 are disposed along adjacent sides of the photodetector 117 in FIG. 7, these circuits may be disposed otherwise. For example, the drive circuit 701 and the readout circuit 702 may be disposed on opposite sides of the photodetector 117.

For the sake of brevity, the photodetector 117 in FIG. 7 is composed of nine pixels (3×3). An actual sensor panel includes the number of photoelectric conversion elements required for the size of the photodetector. For example, an actual sensor panel includes a photodetector 30 cm or more in size (effective region) and at least 2000×2000 pixels at a pixel pitch of 120 μm. The peripheral circuitry 116 in FIG. 3 includes the drive circuit 701 and the readout circuit 702 illustrated in FIG. 7.

Photoelectric conversion elements S1-1 to S3-3 convert light into signal charges. Switching elements T1-1 to T3-3 transmit the signal charges to signal wires Sig1 to Sig3. In the present embodiment, one pixel includes one photoelectric conversion element and at least one switching element. The photoelectric conversion elements S1-1 to S3-3 are connected to a bias power supply Vs. A bias voltage is supplied to one electrode of each of the photoelectric conversion elements S1-1 to S3-3. The switching elements T1-1 to T3-3 are connected to drive wires G1 to G3 for switch gate drive.

The signal wire Sig1 is loaded with the capacitance equivalent to the interelectrode capacitance (Cgs) of three switching elements after the signal charges are transmitted. This is represented by a capacitance element CL1 in FIG. 7. The same applies to the signal wires Sig2 and Sig3. These are represented by capacitance elements CL2 and CL3, respectively.

The photodetector 117 including the photoelectric conversion elements S1-1 to S3-3, the switching elements T1-1 to T3-3, the drive wires G1 to G3, and the signal wires Sig1 to Sig3 is disposed on the insulating substrate 103 (FIG. 1). The drive circuit 701 includes a shift register and controls the on-off of the switching elements T1-1 to T3-3. The drive circuit 701 includes a predetermined number of pairs of flip-flop circuits 701a and AND circuits 701b. Drive signals are output from the AND circuits 701b to the corresponding drive wires G1 to G3.

Light incident on the photoelectric conversion elements S1-1 to S3-3 is converted into electric charges, which are accumulated in the interelectrode capacitances. These electric charges are output as parallel voltage through the switching elements T1-1 to T3-3 and the signal wires Sig1 to Sig3. More specifically, electric charges stored in the interelectrode capacitances of the photoelectric conversion elements S1-1 to S1-3 are transmitted to their respective capacitances CL1 to CL3 of the signal wires Sig1 to Sig3. This transmission increases the electric potential V1 to V3 of the CL1 to CL3 by the number of signal charges. The signals are then processed in the readout circuit.

The readout circuit 702 includes an amplifier and a sample-and-hold capacitor and optionally includes a shift register, an operational amplifier, an A/D conversion circuit, and a memory. The operation of the readout circuit will be described below. The signals of the capacitance elements CL1 to CL3 are transmitted to sample-and-hold capacitors C1 to C3 in the readout circuit 702 by turning on the sample-and-hold (SH) signal. During the transmission, the signals of the capacitance elements CL1 to CL3 are amplified by integrating amplifiers A11 to A13 and variable amplifiers A21 to A23. The integrating amplifiers A11 to A13 are supplied with an electric potential from a reference supply Vref. In the readout circuit 702, switches Sn1 to Sn3 and capacitors C1 to C3 constitute sample-and-hold circuits 703. The integrating amplifiers A11 to A13, the variable amplifiers A21 to A23, and the sample-and-hold circuits 703 constitute amplifier circuits 704.

The signal charges of the sample-and-hold capacitors C1 to C3 are held by turning off the SH signal. After the SH signal is turned off, the capacitance elements CL1 to CL3 are reset by an RC signal to prepare for subsequent transmission.

A first line of signals sampled and held in the sample-and-hold capacitors C1 to C3 sequentially induce a voltage pulse from a shift register 705 to sequentially turn on readout switches Sr1 to Sr3. Through these operations, the first line of signals are converted into serial signals via amplifiers B1 to B3. The serial signals are then subjected to impedance transformation in an operational amplifier 706, are subjected to digital conversion in an A/D conversion circuit 707, and are output to the outside of the sensor panel.

### Second Embodiment

FIG. 4 is a cross-sectional view of a radiation detector according to a second embodiment of the present invention. In FIG. 4, the same parts as in FIG. 1 are denoted by the same reference numerals and will not be further described. The plan view of the radiation detector according to the second embodiment is the same as FIG. 2. A sensor panel of the radiation detector is the same as the sensor panel illustrated in FIG. 3.

A sealing resin 401 in the present embodiment has substantially the same thickness as the scintillator layer 102. The sealing resin 401 can therefore more easily shield radiation than the first embodiment. In the first embodiment, the sensor panel 101 is bonded to the scintillator protection layer 110 with the sealing resin 109. In the present embodiment, after a structure formed of the sealing resin 401 is formed on the periphery of the scintillator layer 102, the scintillator protection layer 110 is formed on the scintillator layer 102 and the sealing resin 401. The sealing resin 401 is disposed on top of the peripheral circuitry 116. As described in the first embodiment, the peripheral circuitry 116 includes at least one of a drive circuit and a readout circuit and is disposed on an insulating substrate. The particles containing an X-ray absorbing material as described in the first embodiment are dispersed in the sealing resin 401. The sealing resin 401 is suitably an ultraviolet (UV) curable resin. The other components are the same as in the first embodiment. The materials of these components are also the same as in the first embodiment. Also in the present embodiment, the scintillator protection layer 110 constitutes a scintillator protection member.

### Third Embodiment

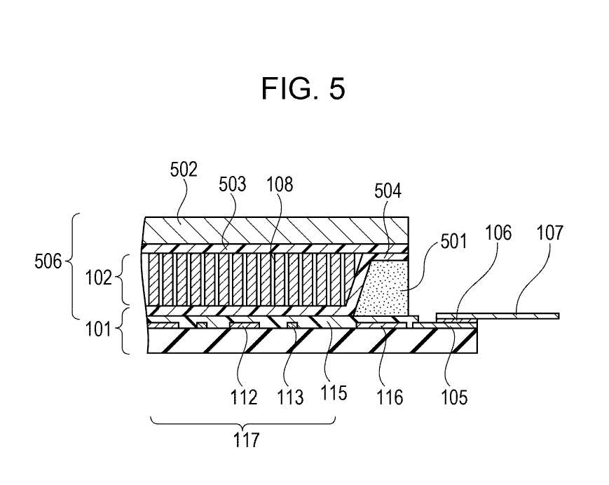

FIG. 5 is a cross-sectional view of a radiation detector according to a third embodiment of the present invention. In FIG. 5, the same parts as in FIG. 1 are denoted by the same reference numerals and will not be further described.

In the present embodiment, the scintillator layer 102 is not directly formed on the sensor panel 101 but is formed on a substrate 502 formed of a reflective material. A reflective-layer-protection layer 503 is formed on the substrate 502. A scintillator layer 102 containing columnar crystals 108 is formed on the reflective-layer-protection layer 503. A scintillator protection layer 504 is formed on the scintillator layer 102, thus constituting a scintillator substrate 506. The scintillator substrate 506 is bonded to the sensor panel 101 such that the scintillator layer 102 is disposed within. The scintillator layer 102 is sealed with a sealing resin 501 between the sensor panel 101 and the substrate 502. In other words, the substrate 502 constitutes a scintillator protection member. The sealing resin 501 is disposed on top of the peripheral circuitry 116. The particles containing an X-ray absorbing material as described in the first embodiment are dispersed in the sealing resin 501. The sealing resin 501 is suitably an ultraviolet (UV) curable resin.

An X-ray detector according to the present invention will be described in detail in the following embodiment.

### Fourth Embodiment

The X-ray detector according to the first embodiment illustrated in FIGS. 1 to 3 is fabricated in the following way.

As illustrated in FIG. 1, a semiconductor thin film formed of amorphous silicon is formed on an insulating glass substrate 103. The semiconductor thin film is used to form photoelectric conversion elements 112 and TFT's (not shown). These elements are connected with wires 113, thus constituting a photodetector 117. The semiconductor thin film is also used to form a peripheral circuitry 116 on the periphery of the photodetector 117. A sensor protection layer (first protective layer) 115 formed of SiN and a scintillator base layer 114 formed by curing a polyimide resin are formed on the photodetector 117, thus constituting a sensor panel 101.

A masking tape is applied to a surface on which no scintillator layer is formed, such as a connecting lead 105, to prevent the formation of a scintillator layer. A scintillator layer 102 formed of a scintillator containing alkali halide columnar crystals (for example, CsI:Tl, thallium-activated cesium iodide) is formed on the scintillator base layer 114 with a scintillator layer deposition apparatus. The scintillator layer 102 having a thickness of 0.35 mm covers the two-dimensional photodetector 117. The observation of the fine structure of the scintillator layer 102 with a scanning electron microscope (SEM) shows that a plurality of columnar crystals 108 illustrated in FIG. 1 are formed with a space interposed therebetween.

After the masking tape is removed, a hot-melt resin containing tungsten fine particles dispersed in a sealing resin 109 is applied to a region 301 in FIG. 3. In other words, the hot-melt resin is applied on top of the peripheral circuitry 116 on the periphery of the scintillator layer 102. As described above, the peripheral circuitry 116 includes at least one of a drive circuit and a readout circuit and is disposed on the insulating substrate 103. The hot-melt resin is a polyolefin hot-melt resin. The tungsten fine particles have an average size of 5 μm. The hot-melt resin has a thickness of 50 μm. The percentage of the tungsten fine particles is 60% by weight.

A sheet is prepared in which an Al film is formed as a reflective layer 111 on a reflective-layer-protection layer (not shown) formed of poly(ethylene terephthalate) (PET). A scintillator protection layer 110 formed of a hot-melt polyolefin resin is attached using a heating roller to a surface of this sheet on which the reflective layer is formed. Thus, a three-layer sheet is formed. The three-layer sheet is placed on the scintillator layer 102 disposed on the sensor panel 101 such that the periphery of the three-layer sheet covers the sealing resin 109. The three-layer sheet is then heated under pressure with a heating roller to melt the scintillator protection layer 110, thereby fixing the three-layer sheet to the scintillator layer 102. Thus, the scintillator layer 102 is surrounded by the three-layer sheet and the sealing resin 109. The sealing resin 109 is further pressed with a heat press bonding bar to improve the adhesion between the scintillator protection layer 110 and the sealing resin 109. For example, the hot pressing is performed for 1 to 60 seconds at a pressure in the range of 1 to 10 kg/cm² and a temperature at least 10° C. to 50° C. higher than the initial melting temperature of the hot-melt resin. Through these processes, an X-ray detector according to the present embodiment is fabricated.

In the structure according to the present embodiment, the scintillator layer 102 on the sensor panel 101 is surrounded by the sealing resin 109 and the three-layer sheet (including the scintillator protection layer 110 and the reflective layer 111) and can be protected from the intrusion of water and other foreign substances. The tungsten fine particles having high X-ray absorption ability dispersed in the sealing resin 109 on top of the peripheral circuitry 116 can reduce the amount of X-ray radiation incident on the peripheral circuitry 116. This can reduce the frequency of malfunctions of the peripheral circuitry 116.

### Fifth Embodiment

In the present embodiment, the tungsten fine particles dispersed in the hot-melt resin used in the first embodiment is replaced with an adhesive tape containing barium oxide (BaO) fine particles. This adhesive tape includes an adhesive layer formed of a hot-melt resin on a tape substrate. The adhesive layer contains barium oxide (BaO) fine particles dispersed therein. The adhesive layer constitutes the sealing resin 109. The barium oxide fine particles have an average size of 5 μm. The hot-melt resin has a thickness of 50 μm. The percentage of the barium oxide fine particles is 70% by weight. The other components are as described in the first embodiment.

The present embodiment can produce substantially the same effects as the first embodiment. More specifically, the present embodiment can prevent the deterioration of the scintillator caused by water intrusion into the scintillator layer and reduce the amount of X-ray radiation incident on the peripheral circuitry.

### Sixth Embodiment

The X-ray detector according to the second embodiment illustrated in FIG. 4 is fabricated in the following way.

In the present embodiment, the sealing resin is a UV-curable epoxy resin, which is blended with tungsten fine particles having an average size of 5 μm. The percentage of the fine particles in the resin is 70% by weight.

After the scintillator layer 102 is formed in the same way as in the first embodiment, the UV-curable resin is applied with a seal dispenser to a region 301 to which the sealing resin is to be applied illustrated in FIG. 3. The application position and weight can be programmed with the seal dispenser. The UV-curable resin is then irradiated with UV light of a UV lamp to cure the resin, forming a sealing resin 401 illustrated in FIG. 4. After UV curing, the sealing resin 401 has a height of approximately 300 μm from the surface of the sensor panel 101 and an average width of approximately 1 mm.

After UV curing, the three-layer sheet (including the scintillator protection layer 110 and the reflective layer 111) as described in the first embodiment is placed on the scintillator layer 102 and the sealing resin 401 and is heated under pressure for fixation. The three-layer sheet is further heated under pressure on the sealing resin 401 in the same manner as in the first embodiment to improve the adhesion between the sealing resin 401 and the scintillator protection layer 110.

As illustrated in FIG. 4, like the first embodiment, the scintillator layer 102 on the sensor panel 101 is surrounded by the sealing resin 401 and the three-layer sheet. Thus, the deterioration of the scintillator can be prevented as in the first embodiment. Furthermore, the amount of X-ray radiation incident on the peripheral circuitry can be reduced as in the first embodiment.

### Seventh Embodiment

The X-ray detector according to the third embodiment illustrated in FIG. 5 is fabricated in the following way.

First, a reflective-layer-protection layer 503 mainly composed of a polyimide resin is formed on a reflective Al substrate 502. A scintillator layer 102 is formed on the reflective-layer-protection layer 503 in the same way as in the first embodiment. A hot-melt resin is used to form a scintillator protection layer 504, thus preparing a scintillator substrate 506.

The scintillator substrate 506 is attached to the sensor panel 101 according to the first embodiment with an adhesive layer (not shown) such that the scintillator layer 102 is disposed within. A sealing resin 501 formed of the UV-curable resin containing X-ray absorbing particles according to the third embodiment is applied on top of the peripheral circuitry 116. The scintillator substrate 506 is bonded to the sensor panel 101 with the sealing resin 501.

In the present embodiment, the reflective substrate 502 corresponds to the scintillator protection member covering the scintillator layer, thus preventing the deterioration of a scintillator as in the first to third embodiments. Furthermore, the X-ray absorbing particles dispersed in the sealing resin on top of the peripheral circuitry can reduce the amount of X-ray radiation incident on the peripheral circuitry as in the first to third embodiments.

### Eighth Embodiment

In the present embodiment, TFT's and peripheral circuitry are formed from a polycrystalline silicon thin film instead of the amorphous silicon thin film according to the fourth embodiment.

As illustrated in FIG. 1, a semiconductor thin film formed of polycrystalline silicon is formed on an insulating glass substrate 103. TFT's are formed from the semiconductor thin film. An amorphous silicon thin film is then used to form photoelectric conversion elements 112. These elements are connected with wires 113, thus constituting a photodetector 117. The polycrystalline silicon semiconductor thin film is used to form peripheral circuitry 116 around the photodetector 117. As described above, the peripheral circuitry 116 includes at least one of a drive circuit and a readout circuit and is disposed on the insulating substrate. For example, a functional circuit, such as a shift register, an amplifier IC, or a memory, is formed for each purpose.

A sensor protection layer (first protective layer) 115 formed of SiN and a scintillator base layer 114 formed by curing a polyimide resin are formed on the photodetector 117, thus constituting a sensor panel 101.

A scintillator and a scintillator protection layer are formed on the sensor panel 101 in the same way as in the first embodiment.

A drive circuit, a TFT, and peripheral circuitry formed of a polycrystalline silicon thin film having a higher switching speed than an amorphous silicon thin film can increase the design flexibility of a detector and peripheral circuitry. For example, a detector having a smaller pixel pitch can be formed. As in the first embodiment, tungsten fine particles having high X-ray absorption ability dispersed in the sealing resin 109 on top of the peripheral circuitry 116 can reduce the amount of X-ray radiation incident on the peripheral circuitry 116 and reduce the frequency of malfunctions of the peripheral circuitry 116.

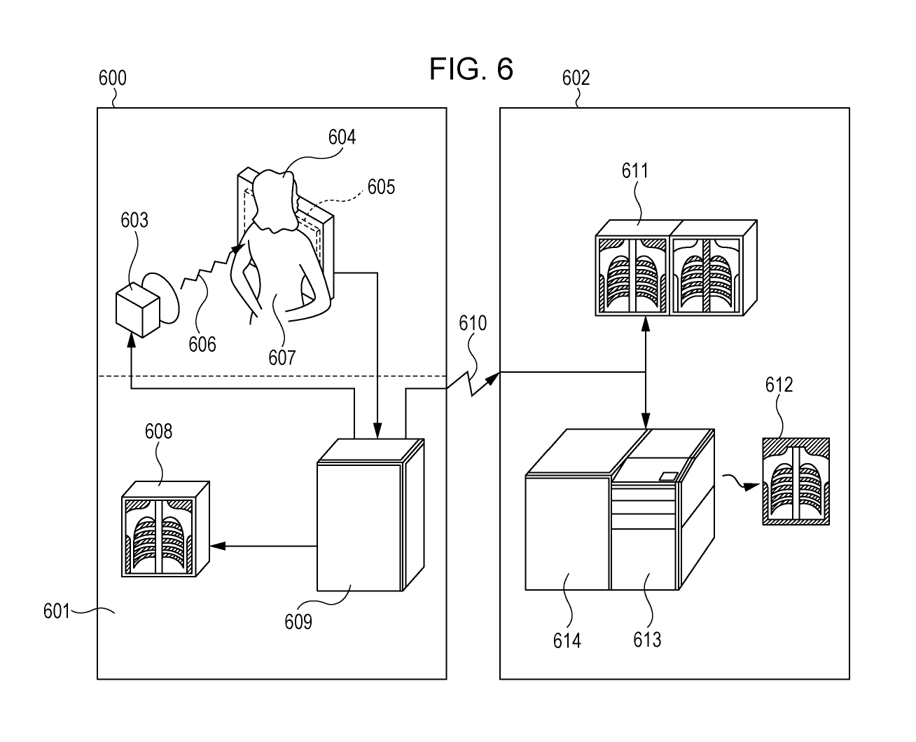

FIG. 6 illustrates an X-ray diagnosis system that includes a radiation detection system according to one embodiment of the present invention. In FIG. 6, an X-ray detector 605 may be a radiation detector as described in the first to third embodiments of the present invention. The X-ray detector 605 may be an X-ray detector as described in the fourth to eighth embodiments.

In FIG. 6, the X-ray diagnosis system includes an X-ray room 600, a control room 601, and a doctor room 602. X-rays 606 generated by an X-ray tube 603 of a radiation source pass through a part 607 of a patient or subject 604 and enter an X-ray detector (image sensor) 605. The incident X-rays contain information on the interior of the body of the patient or subject 604. The incidence of X-rays causes a scintillator (a scintillator layer) in the X-ray detector 605 to emit light, which is photoelectrically converted by photoelectric conversion elements in a sensor panel into electrical information. This information is converted into digital signals. The digital signals are subjected to image processing in an image processor 609. An operator can observe the processed digital signals on a display 608 in the control room 601.

The digital signals can be transferred from the control room 601 to a remote place, such as a remote doctor room 602, through a wireless or wired network 610, such as the Internet or a telephone line. The digital signals thus transferred can be observed on a display 611 in the doctor room 602. The digital signals can be inputted into a recording unit, a film processor 614, or can be recorded on a film 612 with a laser printer 613. A doctor at a remote place can observe the display 611 or the film 612 to diagnose the conditions of the patient or subject 604. The digital signals can be stored in a recording medium, such as an optical disk.

Although the embodiments of an X-ray detector are described above, the present invention is also applicable to an alpha, beta, or gamma ray radiation detector by changing the scintillator. The scintillator may be a known scintillator sensitive to the corresponding radiation. For example, a zinc (silver) sulfide scintillator is known to be sensitive to alpha rays. A plastic scintillator in which an organic fluorescent dye, such as 1,4-bis(5-phenyloxazol-2-yl)benzene (POPOP), is dissolved in plastic, such as polystyrene, is known to be sensitive to beta rays. A thallium-activated sodium iodide single crystal scintillator is known to be sensitive to gamma rays. Use of the radiation-absorbing materials as described in the embodiments can prevent alpha, beta, and gamma rays from entering the peripheral circuitry. Thus, the present invention is applicable to medical X-ray detectors and is also effectively applicable to other uses, such as nondestructive inspection.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-033852 filed Feb. 18, 2010, and No. 2011-009061 filed Jan. 19, 2011, which are hereby incorporated by reference herein in their entirety.

What is claimed is:

1. A radiation detector comprising:
a sensor panel including a photodetector and peripheral circuitry, the photodetector including a two-dimensional array of photoelectric conversion elements arranged on a substrate, the peripheral circuitry being electrically connected to the photoelectric conversion elements and being disposed on a periphery of the photodetector;
a scintillator layer disposed on the photodetector of the sensor panel, the scintillator layer converting radiation into light that is detectable by the photoelectric conversion elements;
a scintillator protection member configured to cover the scintillator layer; and
a sealing resin configured to seal the scintillator layer, the sealing resin being disposed between the sensor panel and the scintillator protection member on the periphery of the scintillator layer,
wherein the sealing resin is disposed on top of the peripheral circuitry, and particles containing a radiation-absorbing material are dispersed in the sealing resin.

2. The radiation detector according to claim 1, wherein the particles containing a radiation-absorbing material comprise X-ray absorbing fine particles.

3. The radiation detector according to claim 2, wherein the X-ray absorbing fine particles comprise an element selected from the group consisting of Mo, W, and Pb.

4. The radiation detector according to claim 2, wherein the X-ray absorbing fine particles comprise a compound selected from the group consisting of BaO, CeO₂, Gd₂O₃, D_{Y2}O₃, and TiO₂.

5. The radiation detector according to claim 1, wherein the ratio of the particles containing a radiation-absorbing material to the total weight of the sealing resin and the particles containing a radiation-absorbing material is 30% by weight or more and 90% by weight or less.

6. The radiation detector according to claim 1, wherein the scintillator layer has a columnar crystal structure and comprises one selected from the group consisting of CsI:Tl, CsI:Na, CsBr:Tl, NaI:Tl, LiI:Eu, and KI:Tl.

7. The radiation detector according to claim 1, wherein the peripheral circuitry disposed on the substrate includes a drive circuit.

8. The radiation detector according to claim 1, wherein the peripheral circuitry disposed on the substrate includes a readout circuit.

9. The radiation detector according to claim 1, wherein the peripheral circuitry disposed on the substrate is disposed around the photodetector.

10. A radiation detection system comprising:
a radiation source configured to produce radiation with which a specimen is irradiated;
a radiation detector according to claim 1, the radiation detector detecting radiation passing through the specimen;
a signal processor configured to perform image processing of a signal detected by the radiation detector; and
a display unit configured to display a signal subjected to image processing by the signal processor.
